(19) United States
(12) Patent Application Publication
(10) Pub. No.: US 2011/0166967 A1
(43) Pub. Date: Jul. 7, 2011

(54) Transaction monitor

(76) Inventor: Robert Bernstein, Chicago, IL (US)

(21) Appl. No.: 12/655,627

(22) Filed: Jan. 4, 2010

(51) Int. Cl. G06Q 10/00; G06Q 30/00; G08B 21/00; G06F 17/00

(52) U.S. Cl. 705/30; 186/53; 340/635; 707/607; 707/E17.01

(57) ABSTRACT

A transaction monitor of an apparatus in one example is configured to determine an occurrence of a transaction between a vendor and a customer at a point of service location. The point of service location comprises a drive-up service location and is operated by the vendor. The transaction monitor comprises a camera component configured to record one or more images of the point of service location prior to, during, and/or after the occurrence of the transaction. The vendor collects a transaction tax for the transaction from the customer for payment to a tax authority. The transaction monitor is configured to maintain a record of the transaction tax that is separate from one or more records maintained by the vendor and/or the tax authority. The transaction monitor is configured to maintain the one or more images with the record of the transaction.

### TECHNICAL FIELD

The invention relates generally to transactions between a vendor and a customer and more particularly to monitoring tax collection of transaction.

### BACKGROUND

Most goods and service vendors collect a tax when completing a sale or transaction. Examples of commonly applied “transaction taxes” include sales tax, value-added tax, customs tax, and use tax, among others. The transaction taxes are established by a tax authority, such as a local, state, or federal government. Calculation of the transaction tax is generally performed at the time of the transaction by the vendor or the vendor's equipment, such as a cash register or computer, and then collected from the customer along with payment for the goods or service. The vendor is then responsible for remitting the transaction tax to the tax authority.

As one means of assurance for collection of the tax, the tax authority is authorized to perform an audit of the vendor. For example, by analyzing the vendor's financial records of past transactions, the total amount of transaction taxes collected over a tax period (i.e., fiscal year, quarter) can be verified. However, due to the time and effort involved in performing an audit, only a small portion of the vendors reporting to a tax authority can be effectively audited.

Thus, a need exists for an improved assurance system for collection of transaction taxes.

### SUMMARY

The invention in one implementation encompasses an apparatus. The apparatus comprises a transaction monitor configured to determine an occurrence of a transaction between a vendor and a customer at a point of service location. The point of service location is operated by the vendor. The point of service location comprises a drive-up service location. The transaction monitor comprises a camera component configured to record one or more images of the point of service location prior to, during, and/or after the occurrence of the transaction. The vendor collects a transaction tax for the transaction from the customer for payment to a tax authority. The transaction monitor is configured to maintain a record of the transaction tax that is separate from one or more records maintained by the vendor and/or the tax authority. The transaction monitor is configured to maintain the one or more images with the record of the transaction.

Another implementation of the invention encompasses a method. A point of service location is monitored for a transaction between a customer and a vendor that operates the point of service location. The transaction comprises a transaction tax for payment to a tax authority. The point of service location comprises a drive-up service location. One or more images of the point of service location are recorded prior to, during, and/or after an occurrence of the transaction. A record of the transaction is created with the one or more images. The record of the transaction is stored separately from one or more records maintained by the vendor and/or the tax authority.

A further implementation of the invention encompasses an article. The article comprises one or more computer-readable signal-bearing media. The article includes means in the one or more media for monitoring a point of service location for a transaction between a customer and a vendor that operates the point of service location, wherein the transaction comprises a transaction tax for payment to a tax authority, wherein the point of service location comprises a drive-up service location. The article further includes means in the one or more media for recording one or more images of the point of service location prior to, during, and/or after an occurrence of the transaction. The article further includes means in the one or more media for creating a record of the transaction with the one or more images. The article further includes means in the one or more media for storing the record of the transaction separately from one or more records maintained by the vendor and/or the tax authority.

### DESCRIPTION OF THE DRAWINGS

Features of example implementations of the invention will become apparent from the description, the claims, and the accompanying drawings in which:

FIG. 1 is a representation of one implementation of an apparatus that comprises a transaction monitor and a tax authority.

FIG. 2 is a representation of another implementation of the apparatus of FIG. 1 and illustrates a local transaction monitor, a remote record manager, and a tax authority.

FIG. 3 is a representation of one implementation of the apparatus of FIG. 2 configured to monitor a drive-through service location.

FIG. 4 is a representation of one implementation of the local transaction monitor 202 and the transaction counter of FIGS. 1 and 2 and further illustrates a messaging device.

FIG. 5 is a representation of one implementation of a plurality of local transaction monitors, a plurality of remote record managers, a regional record manager, and a plurality of tax authorities.

### DETAILED DESCRIPTION

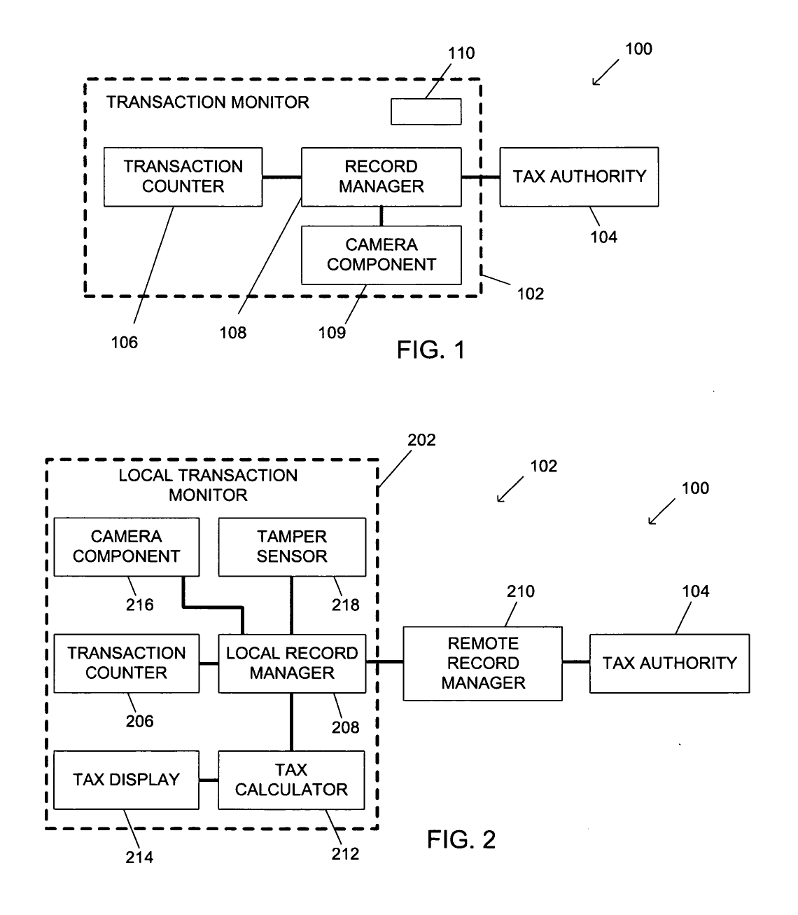

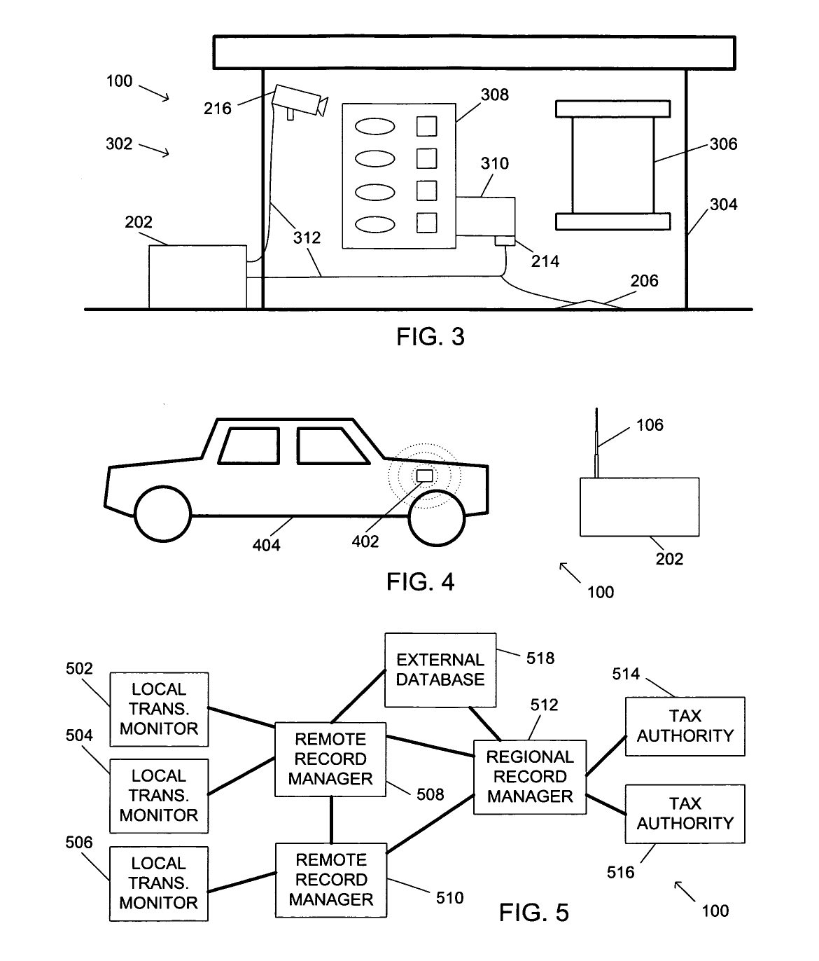

Turning to FIG. 1, an apparatus 100 in one example comprises a transaction monitor 102 and a tax authority 104. Examples of the tax authority 104 comprises local (e.g., town, city or county), state, or federal government entities, or a combination thereof. The transaction monitor 102 in one example comprises a transaction counter 106, a record manager 108, and a camera component 109. In a further example, the transaction monitor 102 comprises an instance of a recordable data storage medium 110, as described herein. The transaction monitor 102 is configured to monitor transactions at a point of service location (POS) 302 (FIG. 3). Examples of the POS 302 comprise a drive-through service station, drive-through restaurant, drive-up automated teller machine (ATM), storefront, cash register, electronic purchasing system, and others, as will be appreciated by those skilled in the art. In implementations where the POS 302 is a drive-through service location, it may provide a convenience for the customer which allows the customer to more quickly execute the transaction, for example, by avoiding additional steps of parking their car, walking into the store, and returning to their car.

The POS 302 is operated by a vendor, such as a bank, restaurant, franchise, retailer, or other business entity. The vendor operates the POS 302 to conduct business with a customer, for example, one or more of initiating, continuing, performing, and/or completing a transaction for a service or purchase. The tax authority 104 requires transaction taxes on the transactions between the vendor and its customers to be collected, for example, one or more of sales tax, value-added tax, customs tax, and use tax, and other applicable taxes for a jurisdiction in which the POS 302 is located. In one example, the taxes also include a “drive-through tax” as a use tax for transactions associated with a customer who does not leave their car or motorized vehicle or uses a drive-through point of service location, for example, POS 302. The POS 302 in one example is configured, operated, or instructed by the vendor to collect the transaction tax.

The transaction counter 106 is configured to determine an occurrence of a transaction between the vendor and the customer at the POS 302. For example, the transaction counter 106 determines one or more of an occurrence of a sale, purchase, ATM withdrawal, financial service, a use of a drive-through POS 302, or other transaction, as will be appreciated by those skilled in the art. Examples of the transaction counter 106 comprises a pressure sensor, roll-over sensor, magnetic sensor, optical sensor, thermal sensor, motion sensor, audio sensor, or messaging device. For example, the transaction counter 106 is configured to sense the presence of the customer and/or the customer's vehicle. In another example, the transaction counter 106 is configured to determine when a service window 306 (FIG. 3) for the POS 302 is opened or when a cash register (not shown) for the POS 302 is opened.

The record manager 108 is configured to manage data associated with the transaction monitor 102. In one example, the record manager 108 comprises a processor, computer, server, or other data processing unit. In a further example, the record manager 108 comprises a data storage device, such as a hard drive, memory unit, or an instance of the recordable data storage medium 110. The record manager 108 in one example comprises a transaction tax database for storing records of transactions for the POS 302. The camera component 109 in one example is configured to record one or more images of the POS 302 prior to, during, and/or after an occurrence of the transaction, as described herein. The camera component 109 in one example comprises an interne camera, wireless camera, or other digital camera device.

The transaction monitor 102 is configured to securely maintain records of the transactions at the POS 302 from interference or tampering, for example, to ensure an accurate representation of the transactions and associated data at the POS 302. The transaction monitor 102 in one example is shielded from communications and/or interference. For example, the transaction monitor 102 is shielded from undesired communications and/or interference from any of: the POS 302, the customer, the vendor, personnel and/or equipment associated with the vendor, or other sources, as will be appreciated by those skilled in the art. Examples of the communications comprise electrical, electronic, optical, and/or wireless communications. Examples of interference comprise electrical, electronic, electromagnetic, optical, radiofrequency, magnetic, and/or physical interference. In alternative implementations, desired communications between the transaction monitor 102 are provided for over a secure channel or communication path.

Accordingly, the transaction monitor 102 comprises or acts as a trusted third party between the vendor and the tax authority 104. In a further example, the transaction monitor 102 provides a stand-alone tax verification system which is separate from the POS 302, the vendor, and the tax authority 104.

The transaction monitor 102 is further configured to generate a report for the tax authority based on the transaction tax database. In one example, the report comprises an indication of a total amount of tax due to the tax authority from the vendor based on the transactions that were processed. The report in one example comprises relevant tax information such as a tax identification number for the vendor, a business name for the vendor, an address or location of the POS 302, financial statistics or information based on or derived from the transaction tax database, and other information, as will be appreciated by those skilled in the art. The transaction monitor 102 in one example generates the report upon completion of a predetermined tax period, for example, every week, month, quarter, or fiscal year. In another example, the transaction monitor 102 generates the report when an amount of the tax due exceeds a predetermined threshold or when the report is requested by the tax authority. In another implementation, the transaction monitor 102 is configured to collect or obtain the transaction tax from the vendor on behalf of the tax authority 104. For example, the transaction monitor 102 performs an electronic funds transfer from an account of the vendor. In this implementation, the transaction taxes or a portion thereof are transmitted to the tax authority along with the report, as will be appreciated by those skilled in the art.

Turning to FIG. 2, another implementation of the apparatus 100 comprises a local transaction monitor 202, a remote record manager 210, and the tax authority 104. The local transaction monitor 202 and the remote record manager 210 in one example cooperate to provide the functionality of the transaction monitor 102 in a distributed configuration. For example, a plurality of local transaction monitors 202 may be linked with one or more remote record managers 210.

The local transaction monitor 202 in one example comprises and/or is communicatively coupled with one or more of a transaction counter 206, a local record manager 208, a tax calculator 212, a tax display 214, a camera component 216, and a tamper sensor 218. The transaction counter 206 functions analogously to the transaction counter 106. The local record manager 208 in one example securely maintains records for one or more assigned POS 302. For example, the local record manager 208 is configured to maintain records for one or more POS 302 with a same vendor, such as several drive-through windows of a bank or a plurality of cash registers at a counter in a restaurant, as will be appreciated by those skilled in the art.

The tax calculator 212 in one example determines an amount of tax to be charged to the customer for a specific transaction and the tax display 214 displays the amount of tax to one or more of the customer and the vendor (or an employee of the vendor). The tax calculator 212 in one example determines the amount of the tax based on one or more of time of day for the transaction, a number of vehicles waiting at the POS 302, wait time for the customer, a type of vehicle used by the customer or characteristics of the vehicle, the location of the POS 302, and a goods and/or service charge for the transaction (i.e., a percentage of the goods/service price). In another example, the tax calculator 212 communicates with an external database 518 (FIG. 5) or information store to retrieve information for determination of the amount of the tax. The tax calculator 212 may communicate directly with the external database 518 or through one or more of the remote record managers (i.e., as an intermediary). In another example, the tax calculator 212 selects a flat tax for the transaction tax from a pre-determined table. Other criteria for determining the tax amount will be apparent to those skilled in the art. In one example, the tax calculator 212 is configured to increase the transaction tax in order to reduce the environmental impact of the vehicles using the POS 302, for example, by taxing the use of the POS 302.

The camera component 216 in one example is analogous to the camera component 109 and configured to record one or more images of the POS 302 prior to, during, and/or after an occurrence of a transaction. In a further example, the camera component 216 records continuous video of the POS 302, video for a portion of the transaction, and/or video for all of the transaction. The transaction monitor 102 is configured to store the images and/or video associated with the transaction with the record of the transaction. Examples of the camera component 216 comprise closed circuit television (CCTV) cameras, charge coupled device (CCD) cameras, and other image or video recorders, as will be appreciated by those skilled in the art.

The tamper sensor 218 is configured to provide an alert upon an occurrence of suspected interference or tampering with one or more of the local transaction monitor 202, the POS 302 or cash register, an interface between the cash register and the local transaction monitor 202, or an interface/communication path between the local transaction monitor 202 and the remote record manager 210. For example, the tamper sensor 218 senses excessive vibration, physical impact, signal degradation, or other issues which may indicate a problem with the transaction monitor 102. Accordingly, the tamper sensor 218 can provide a request for service or verification of operation to a manager or operator of the local transaction monitor 202. In another example, the tamper sensor 218 provides secure communication between the local transaction monitor 202 and the remote record manager 210, for example, via encryption protocols or keep-alive messages/signals.

Turning to FIG. 3, another implementation of the apparatus 100 is shown at the POS 302. The POS 302 in this example comprises a drive-through restaurant 304. The drive-through restaurant 304 comprises a service window 306, a menu 308, and an order display 310. The transaction counter 206 of FIG. 3 is a roll-over sensor which indicates when the customer's vehicle is present. The tax display 214 is located adjacent to the order display 310 so the customer can see the transaction tax prior to completing the transaction. Communication links or cables 312 link the transaction counter 206, the tax display 214, and the camera component 216 to the transaction monitor 102, as will be appreciated by those skilled in the art. The communication links 312 may be electrical, electronic, optical, and/or wireless communication links.

Turning to FIG. 4, in one example where the transaction counter 106 comprises a messaging device, the transaction counter 106 is configured to communicate with a sensor or messaging device associated with the customer and/or the customer's vehicle, for example, messaging device 402 in a customer's vehicle 404. The messaging device 402 in one example comprises a passive messaging device, such as a radio frequency ID tag or transponder. In a further example, the transponder operates with an existing electronic toll collection system, such as I-Pass (Illinois Tollway, Downers Grove, Ill.; www.illinoistollway.com). In this way, the transaction tax can be obtained through existing channels provided by the electronic toll collection system. In yet another example, the messaging device 402 comprises an active communication device which sends messages to and/or receives messages from the transaction counter 106. In one example, the messages contain characteristics of the customer's vehicle, such as engine displacement, fuel efficiency, gross vehicle weight, current or maximum occupancy, or other criteria which may be used by the tax calculator 212. Alternative examples of the transaction counter 106 and the messaging device 402 may be implemented as a bar-code label and scanner system, magnetic reader system, short range radio communication system, infrared communication system, or other communication systems such as On-Star (Detroit, Mich.; www.onstar.com), as will be appreciated by those skilled in the art.

An illustrative description of operation of the apparatus 100 is presented, for explanatory purposes. Referring to the implementation of FIG. 3, the POS 302 is a drive-through restaurant 304. A customer approaches the menu 308 to place an order, for example, to perform a transaction with the vendor. The camera component 216 is configured to capture images of the customer at the menu 308 and/or at the service window 306.

In one example, the transaction tax for the transaction is calculated or estimated prior to completion of the transaction. The local transaction monitor 202 calculates the transaction tax and displays it on the tax display 214. The tax display 214 may be positioned such that it is viewable by one or more of the customer, the vendor, and/or the camera component 216. In a further example, multiple tax displays 214 are employed, such as a first tax display viewable by the customer and a second tax display viewable by the vendor. The tax display 214 in one example allows the vendor to manually enter the transaction tax into a cash register and/or their own records (i.e., a business ledger, accounting system, or receipt system). In this way, the vendor can incorporate the transaction tax in a built-in display of the POS 302, for example, the order display 310. In another implementation, the transaction tax amount is automatically entered. For example, the local transaction monitor 202 is communicatively coupled with the cash register and electronically communicates the transaction tax amount to the cash register.

The transaction counter 206 determines an occurrence of the transaction between the vendor and the customer. In the example of FIG. 3, the transaction counter 206 is a roll-over strip counter. As the customer's vehicle rolls over the transaction counter 206 at the service window 306, the transaction counter 206 communicates the occurrence of the transaction to the local transaction monitor 202. The local record manager 208 of the local transaction monitor 202 stores a record of the transaction. In one example, the record comprises at least one image of the customer at the service window 306 from the camera component 216 as photographic proof of the transaction. In a further example, a license plate of the customer's vehicle is scanned or “read” and used to determine characteristics of the vehicle. The license plate and related information (e.g., registered owner, vehicle characteristics, etc.) in one example is looked up from an external database 518 (FIG. 5), such as a department of motor vehicles or other information store. The images in one example are recorded with additional information to uniquely identify the transaction, such as a time/date stamp, transaction number, an amount or value of the order, or other information related to the order. The local record manager 208 in one example stores the record in a database, as described above. The images and transaction record allow the tax authority 104 to more easily audit the vendor and/or POS. For example, the images are more difficult to dispute as a source of evidence.

Records from a plurality of transactions are stored by the local record manager 208 as described above. The local record manager 208 maintains the records separately and/or securely from other information or records maintained by the vendor or the tax authority. The local record manager 208 in one example transmits and/or uploads the records of the transactions to the remote record manager 210. The transmission of the records may be automatic (i.e., on a predetermined schedule) or triggered by a condition or request, such as if the database reaches a predetermined size or if the tamper sensor 218 indicates an attempt at tampering with the local transaction monitor 202. The remote record manager 210 generates the report for the tax authority, as described above.

Turning to FIG. 5, the apparatus 100 in another implementation comprises a plurality of local transaction monitors 502, 504, and 506, a plurality of remote record managers 508 and 510, one or more regional record managers 512, a plurality of tax authorities 514 and 516, and one or more external databases 518. The local transaction monitors 502, 504, and 506 are analogous to local transaction monitor 202. The remote record managers 508 and 510 are analogous to remote record manager 210. The regional record manager 512 in one example provides a central processing capability for a transaction tax system within a region. For example, the regional record manager 512 is configured to store, process, and generate the reports for the tax authorities 514 and 516. The external database 518 comprises any information store or repository with information that may be utilized by the local transaction monitors 502, 504, and 506, the remote record managers 508 and 510, and/or the regional record manager 512. Examples of the external database 518 comprise a department of motor vehicles or other government entity with information for registered vehicles, a financial institution or bank, or other government agencies.

The regional record manager 512 in one example is communicatively coupled with a plurality of remote record managers in a predetermined region or geographic area, such as remote record managers 508 and 510. In another example, a remote record manager and regional record manager are combined into a single device or server, or a remote record manager provides the capabilities of the regional record manager. The regional record manager 512 in one example is configured to communicate or act as a gateway to the tax authorities 514 and 516. In one example, the tax authorities are separate entities, such as a city government revenue department and state government revenue department. The local transaction monitors 502, 504, 506, the remote record managers 508 and 510, and the regional record manager 512 in one example are configured with redundancy to reduce the impact of a failure of an individual component or communication link. A failure of or problem with a component or communication link in one example is detected by the tamper sensor 218. In a further example, each component maintains a list of backup components or communication links as alternates in case of a failure. For example, the local transaction monitor 504 may report to the remote record manager 508 initially, but report to remote record manager 510 if a problem occurs with a communication link to the remote record manager 508.

The records and/or report in one example can be modified by an operator of the transaction monitor 102. For example, if an operator of the POS 302 notes a discrepancy in the records (i.e., due to a transaction being canceled or modified), he can call or contact the operator of the transaction monitor 102. Since the transaction monitor 102 maintains a separate record from the operator of the POS 302, explicit approval must be obtained for any changes to the records. In one example, the records are marked with a creation timestamp, modification timestamp, and employee ID or other identifier of a person that authorizes the modification, as will be appreciated by those skilled in the art.

The apparatus 100 in one example provides an accurate verification of taxes paid at the POS 302, even if the taxes are collected in cash, i.e., without the use of an electronic register. The use of the camera component 216 provides assurances against the vendor using two sets of accounting books, cash registers without register tapes, or other tax fraud or evasion techniques. While a description of several implementations has been provided, alternate configurations of the components (i.e., tax calculator, transaction monitor, local transaction monitor, remote record manager, etc.) will be apparent to those skilled in the art. For example, the tax calculator 212 may be located at a remote record manager 210. In this implementation, the function of the tax calculator may be provided at a more centralized location and used by several local transaction monitors that are serviced by the remote record manager. Other arrangements of hierarchy between the local transaction monitors, remote record managers, and regional record managers will be apparent to those skilled in the art.

The apparatus 100 in one example comprises a plurality of components such as one or more of electronic components, hardware components, and computer software components. A number of such components can be combined or divided in the apparatus 100. For example, the transaction monitor 102, the local transaction monitor 202, the remote record manager 210, and/or the components therein can be combined or divided. An example component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. The computer-readable signal-bearing media store software, firmware and/or assembly language for performing one or more portions of one or more implementations of the invention. Examples of a computer-readable signal-bearing medium for the apparatus 100 comprise the recordable data storage medium 110 of the transaction monitor 102. The computer-readable signal-bearing medium for the apparatus 100 in one example comprise one or more of a magnetic, electrical, optical, biological, and atomic data storage medium. For example, the computer-readable signal-bearing medium comprise floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A system, comprising:
a transaction monitor configured to determine an occurrence of a transaction between a vendor and a customer at a point of service location, wherein the point of service location is operated by the vendor;
wherein the point of service location comprises a drive-up service location;
wherein the transaction monitor comprises a camera component;
wherein the camera component is configured to record one or more images of the point of service location prior to, during, and/or after the occurrence of the transaction;
wherein the vendor collects a transaction tax for the transaction from the customer for payment to a tax authority;
wherein the transaction monitor is configured to maintain a record of the transaction tax that is separate from one or more records maintained by the vendor and/or the tax authority;
wherein the transaction monitor is configured to maintain the one or more images with the record of the transaction tax.

2. The system of claim 1, wherein the transaction monitor comprises a local transaction monitor and a remote record manager;
wherein the local transaction monitor is configured to determine the occurrence of the transaction;
wherein the remote record manager is located remotely from the local transaction monitor and configured to maintain the one or more images and the record of the transaction tax.

3. The system of claim 1, wherein the transaction monitor is configured to securely maintain the record of the transaction from interference or tampering.

4. The system of claim 3, wherein the transaction monitor is shielded from communications or interference.

5. The system of claim 4, wherein the transaction monitor is shielded from communications or interference from one or more of:
the point of service location,
the customer,
the vendor, and
equipment or personnel associated with the vendor.

6. The system of claim 3, wherein the transaction monitor comprises a tamper sensor configured to provide an alert upon an occurrence of suspected interference or tampering with the transaction monitor.

7. The system of claim 1, wherein the transaction monitor comprises a local transaction monitor and a remote record manager in a distributed configuration.

8. The system of claim 1, wherein the transaction monitor comprises a trusted third party between the vendor and the tax authority.

9. The system of claim 1, wherein the transaction monitor comprises a transaction tax database;
wherein the transaction monitor stores a plurality of records in the transaction tax database;
wherein the plurality of records comprise the record of the transaction tax.

10. The system of claim 9, wherein the transaction monitor is configured to generate a report for the tax authority based on the transaction tax database.

11. The system of claim 1, wherein the drive up service location is a drive-up restaurant window and the vendor is a drive-up restaurant operator.

12. A method, comprising the steps of:
monitoring a point of service location for a transaction between a customer and a vendor that operates the point of service location, wherein the transaction comprises a transaction tax for payment to a tax authority, wherein the point of service location comprises a drive-up service location;
recording one or more images of the point of service location prior to, during, and/or after an occurrence of the transaction;
creating a record of the transaction with the one or more images;
storing the record of the transaction separately from one or more records maintained by the vendor and/or the tax authority.

13. The method of claim 12, wherein the step of storing the record comprises the step of:
securely storing the record in a transaction tax database.

14. The method of claim 13, further comprising the step of:
monitoring the transaction tax database for interference or suspected tampering.

15. The method of claim 13, further comprising the step of:
generating a report for the tax authority based on the transaction tax database.

16. The method of claim 12, further comprising the step of:
collecting the transaction tax from the vendor that operates the point of service location.

17. An article, comprising:
one or more computer-readable signal-bearing media; and
means in the one or more media for monitoring a point of service location for a transaction between a customer and a vendor that operates the point of service location, wherein the transaction comprises a transaction tax for payment to a tax authority, wherein the point of service location comprises a drive-up service location;
means in the one or more media for recording one or more images of the point of service location prior to, during, and/or after an occurrence of the transaction;
means in the one or more media for creating a record of the transaction with the one or more images; and
means in the one or more media for storing the record of the transaction separately from one or more records maintained by the vendor and/or the tax authority.

18. The article of claim 17, wherein the means in the one or more media for storing the record comprises:
means in the one or more media for securely storing the record in a transaction tax database.

19. The article of claim 18, further comprising:
means in the one or more media for monitoring the transaction tax database for interference or suspected tampering.

20. The article of claim 18, further comprising:
means in the one or more media for generating a report for the tax authority based on the transaction tax database.
